(19) United States
(12) Patent Application Publication
(10) Pub. No.: US 2008/0046455 A1
(43) Pub. Date: Feb. 21, 2008

(54) QUERY FEEDBACK-BASED CONFIGURATION OF DATABASE STATISTICS

(75) Inventors: ALEXANDER BEHM, FRANKFURT AM MAIN (DE); PETER JAY HAAS, SAN JOSE, CA (US); VOLKER GERHARD MARKL, SAN JOSE, CA (US)

Correspondence Address: SHIMOKAJI & ASSOCIATES, P.C., 8911 RESEARCH DRIVE, IRVINE, CA, 92618, US

(73) Assignee: INTERNATIONAL BUSINESS MACHINES CORPORATION, Armonk, NY (US)

(21) Appl. No.: 11/465,014

(22) Filed: Aug. 16, 2006

(51) Int. Cl. G06F 7/00

(52) U.S. Cl. 707/102

(57) ABSTRACT

A method is disclosed for automatically configuring database statistics by: collecting information from a database system, the database information including data query feedback; consolidating and formatting the database information into a plurality of intervals; converting the plurality of intervals into a plurality of non-overlapping buckets; computing frequencies for the buckets by solving a constrained maximum entropy problem to create a proxy data distribution function; and using the proxy data distribution function to determine a set of statistics to maintain for the database information.

### CROSS-REFERENCE TO RELATED APPLICATIONS

The present invention is related to commonly-assigned U.S. Pat. No. 6,763,359B2 “Learning from Empirical Results in Query Optimization” issued 13 Jul. 2004; to commonly-assigned application Ser. No. 10/864,463 “Detecting Correlation from Data” filed on 10 Jun. 2004 and published on 15 Dec. 2005 as US2005/0278357A1; to commonly assigned application Ser. No. 10/904,241 “System and Method for Updating Database Statistics According to Query Feedback” filed on 29 Oct. 2004; and to commonly assigned application Ser. No. 11/457,418 “Consistent and Unbiased Cardinality Estimation for Complex Queries with Conjuncts of Predicates” filed on 13 Jul. 2006.

### BACKGROUND OF THE INVENTION

1. Field of Invention

The present invention relates generally to the field of database query optimization. More specifically, the present invention is related to query feedback-based configuration of database statistics.

2. Discussion of Prior Art

Conventional database systems typically utilize a cost-based model for selecting an execution plan for a given query. Accordingly, a query optimizer may utilize statistical information on the data in the database system, because the costs of a database query are related to the distribution of the resident data. The quality of the statistical information provided to the query optimizer may have a direct impact on the quality of the selected execution plan choice and, consequently, on the performance of the query execution.

Because of storage limitations, a small collection of database statistics is typically maintained for each of a set of individual columns from the tables in the database. Statistics configuration methods may be used to determine precisely which single-column, or other, database statistics to collect and maintain for use by the query optimizer. For example, it may be desirable to store the n most frequent values and m quantiles for a column, where the statistics-configuration parameters n and m may be determined either manually or automatically. Conventional statistics-configuration methods typically disregard the statistical interdependence between frequent values and quantiles. This may lead to inconsistent and non-optimal choices for the number of these statistics to maintain.

Without an automatic method of configuring statistics, the set of statistics to collect and maintain must be determined manually by, for example, a Database Administrator. Manual configuration of statistics may not only increase total administration costs but may also reduce performance results when the Database Administrator lacks appropriate expertise. As can be seen, there is a need for an automatic and autonomous method of configuring statistics, which becomes more apparent as query optimization places greater reliance on ever more sophisticated statistical information.

### SUMMARY OF THE INVENTION

The present invention is a method for configuring database statistics that comprises: collecting information from a database system, the database information including data query feedback; creating a proxy data distribution function, and using the proxy data distribution function to configure the database statistics.

In another embodiment of the present invention, a method for configuring database statistics obtained from a database system comprises: consolidating and formatting a histogram from the database based on query feedback data, and other statistical data derived from the data tables, into a set of interval values; deriving a set of non-overlapping bucket values from the set of interval values; executing an iterative scaling algorithm, Newton-Raphson method, or Simplex method to derive a frequency value for each bucket based on the maximum-entropy principle; converting the bucket frequency values into a proxy data distribution function; and using the proxy data distribution function to determine which statistics to maintain.

In yet another embodiment of the present invention, a database system for configuring database statistics comprises a database for storing data tables; a system catalog in communication with the database, the system catalog for storing statistical information derived from the data tables; and a feedback warehouse in communication with the database, the feedback warehouse for storing query results and estimated cardinalities of intermediate steps of previously-executed database queries.

These and other features, aspects and advantages of the present invention will become better understood with reference to the following drawings, description and claims.

### BRIEF DESCRIPTION OF THE DRAWINGS

FIG. 1 illustrates a database system including a Database, a System Catalog, and a Feedback Warehouse, in accordance with the present invention;

FIG. 2 illustrates a graph showing a cumulative distribution function, a linear interpolation curve, and an estimation error, in accordance with the present invention;

FIG. 3 is a flow chart providing a general overview of a process for query feedback-based configuration of database statistics as can be used with the database system of FIG. 1, in accordance with the present invention;

FIG. 4 graphically illustrates a relationship between intervals and buckets, in accordance with the present invention;

FIG. 5 illustrates a search conducted in two dimensions, in accordance with the present invention;

FIG. 6 is a graphical three-dimensional representation of the distance between a proxy data distribution function and the query optimizer's coarse distribution function, for different possible values of certain database statistics-configuration parameters;

FIG. 7 is a first graphical illustration of a sweep line algorithm adapted for use in determining the intersection of intervals in a one-dimensional histogram, in accordance with the present invention; and

FIG. 8 is a second graphical illustration of a sweep line algorithm functioning to determine interval boundaries, in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Traditionally a Database Administrator determines statistics-configuration parameters, such as the number of frequent values and quantiles to collect and maintain for a given column, adding to administration costs. Such costs may be reduced with implementation of the inventive method, which may lead to a reduction of the total cost of ownership. By automatically configuring the number of frequent values and quantiles to maintain, query execution performance can be improved in accordance with the present invention due to better statistical information. Additionally, the database may gain in adaptivity to changes in data, as the optimal number of frequent values and quantiles to be maintained for each column automatically evolves over time.

In the present state of the art, statistics-configuration methods disregard the fact that the configuration parameters “number of frequent values” and “number of quantiles” are statistically dependent. As a result, conventional methods do not choose these parameters in an automatic, consistent or effective manner. The inventive method, disclosed below, uses query feedback and may incorporate other current statistical information to create a maximum-entropy cumulative frequency distribution function, or proxy data distribution function, which serves as a proxy for the true data distribution.

The query optimizer, when choosing query plans, may use a coarse approximation to the true data distribution, where the coarse approximation is derived from the small set of database statistics maintained by the system. The disclosed method automatically selects an optimal set of database statistics to maintain so as to minimize the error between the query optimizer's coarse distribution and a less coarse maximum-entropy distribution. This choice approximately minimizes the error between the query optimizer's coarse distribution and the true data distribution, thereby leading to good choices of query plans by the query optimizer. In one embodiment of the inventive method, the number of frequent values n and the number of quantiles m are selected so as to minimize the error between the coarse distribution function and the proxy data distribution function.

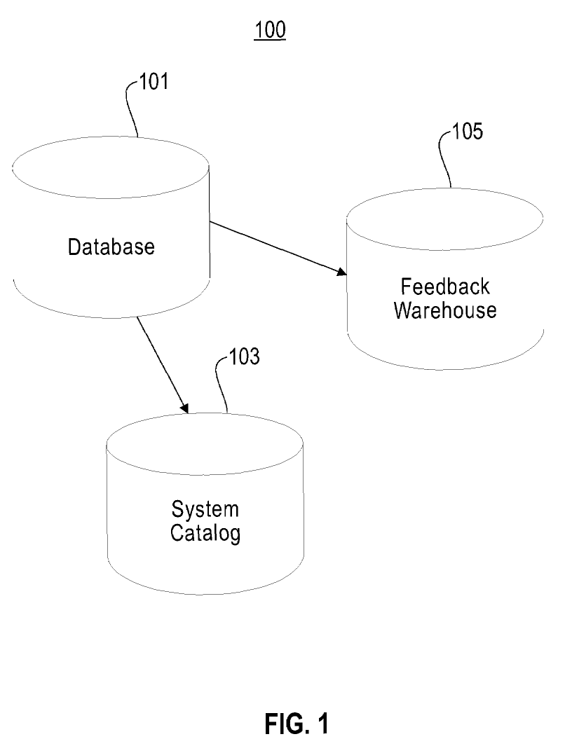

Referring now to FIG. 1, there is shown a data flow in an exemplary hardware environment that may be used with an embodiment of the present invention. A database system 100 may comprise a database 101, a System Catalog 103, and a Feedback Warehouse 105. In an embodiment, the database 101 may comprise a DataBase2 (DB2™) offered by IBM Corporation, although those skilled in the art may readily appreciate that the database 101 need not be a relational database and, moreover, may comprise a conventional database.

The System Catalog 103 may store statistical information derived from data tables in the database 101, in a format such as a data histogram. For example, the System Catalog 103 may store the absolute or relative cardinality of the most frequent values in a plurality of single columns, or may store a set of quantiles for a plurality of column distributions. The Feedback Warehouse 105 may include actual results and estimated cardinalities of intermediate steps of previously-executed database queries. Accordingly, accurate information of the actual distribution of data may be available from the System Catalog 103 or the Feedback Warehouse 105 as required.

For clarity of illustration, the detailed description below utilizes integer-valued column data to describe the currently contemplated modes of carrying out the invention. However, it should be understood that the invention modes of operation can be extended to real-valued data and other types of interval data using methods known to those skilled in the art. Additionally, the column of data may be obtained directly from a stored database table, or may be derived from the base data. More generally, the term “column of data” as used herein should be understood to include any set of numerical values stored by the database system.

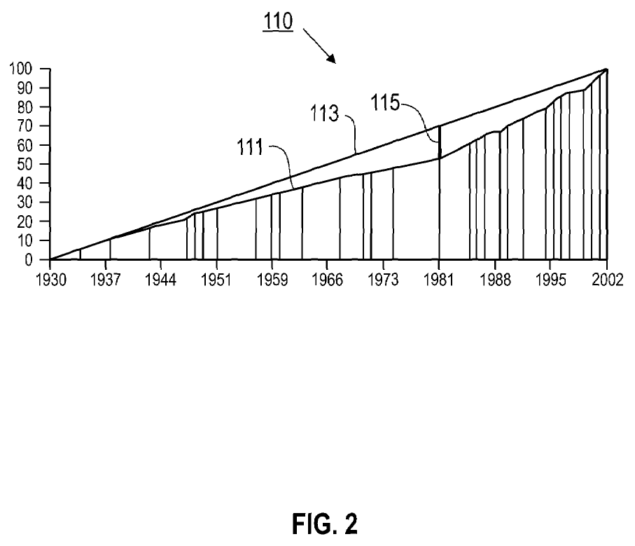

Using the inventive method, a maximum entropy distribution may be computed and graphed using data in the Feedback Warehouse 105 and, optionally, using data in the System Catalog 103. An example is provided in FIG. 2, showing a graph 110 with a cumulative distribution function 111. In a conventional database system, the query optimizer's coarsified distribution, which is a function of a candidate set of maintained single-column statistics (e.g., a candidate number n of frequent values and a candidate number m of quantiles), may be based on a linear interpolation curve 113. An estimation error 115 may be determined as a function of a distance measure, such as a Kolmogorov-Distance or an Lₚ distance, and may be used to ascertain the quality of the candidate set of proposed statistics, for example, the candidate values of n and m.

In an embodiment of the present invention, the estimation error 115 between the maximum-entropy cumulative frequency distribution function 111 and the optimizer's coarse distribution function 113, the latter of which is based on an ad hoc choice of the number n of frequent values and the number m of quantiles, can be minimized by using optimal values of the parameters n and m, resulting in a smaller estimation error by the query optimizer. In an alternative embodiment, the values of n and m can be chosen to minimize the errors in computing selectivities for a specified set of predicates based on the interpolation function relative to computing selectivities for these predicates based on the maximum-entropy distribution. The specified set of predicates may be obtained from a query workload.

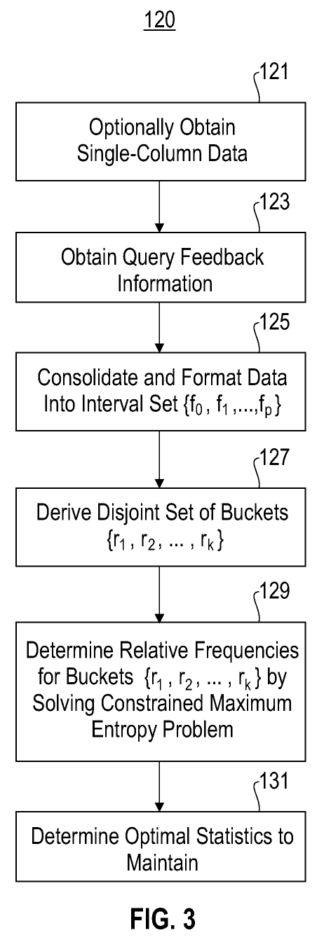

The data flow executed by the database system 100 can be described with additional reference to a flowchart 120, shown in FIG. 3. The flowchart 120 provides a general overview of the disclosed process of the present invention. Single-column data, such as in the form of a histogram, or other statistics may be collected or obtained from the System Catalog 103, at step 121. In an alternative embodiment, single-column data may also optionally be obtained “on the fly,” in step 121, without recourse to the System Catalog 103, by a process of scanning or sampling the database 101, using techniques known to those skilled in the art. The Database Administrator may provide an input as to the usual type of queries to be run on the database 101, in order to help guide the process of scanning or sampling the database 101. As understood by one skilled in the art, the obtained histogram data may be provided in a format having regular, non-overlapping intervals, and may include a range of values lying between a minimum histogram value l₀ and a maximum histogram value u₀.

Query Feedback information, such as query feedback and sample queries (e.g., ‘most frequent’ queries), may be obtained from the Feedback Warehouse 105, at step 123. In contrast to the histogram presentation of data, executed queries do not typically provide data in regular, non-overlapping intervals. The Query Feedback information may comprise stored information obtained from previously-executed Query Feedback Records and existing query statistics. In an alternative embodiment, Query Feedback information may be obtained on the fly, in step 123, without recourse to the Feedback Warehouse 105, by a process of issuing queries against the database 101. The Database Administrator may provide an input as to the usual type of queries to be run on the database 101, in order to help determine which queries to run on the fly. Thus, query-related information can be obtained reactively after queries have been executed, or proactively by determining the queries of interest and then gathering the information.

At step 125, the single-column data may be consolidated with the Query Feedback, and the resulting information may be formatted into a set {I} that can be represented by a sequence of triples having the form:

{I}={(l₁,u₁,f₁),(l₂,u₂,f₂), . . . ,(l_{N},u_{N},f_{N})}

where, for N Query Feedback Records iε{1,2, . . . ,N},

lᵢ is the lower boundary (i.e., minimum value) of the i-th interval;

uᵢ is the upper boundary (i.e., maximum value) of the i-th interval; and

fᵢ is the relative frequency of occurrence of the values between lᵢ and uᵢ

### As understood by one skilled in the relevant art, a Query Feedback Record stating that P(A<X≦B)=F may be equivalent to a triple designated by the expression (A, B, F).

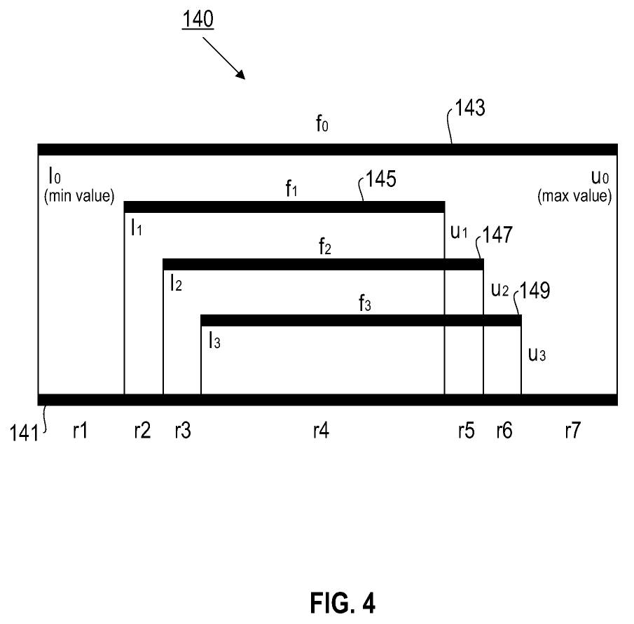

The consolidated information obtained at step 125 yields an interval set 140, as shown in FIG. 4. The interval set 140 may be plotted along a horizontal coordinate axis 141 extending from the minimum histogram value l₀ to the maximum histogram value u₀. The interval set 140 thus may include both non-overlapping information related to the single-column data retrieved from the System Catalog 103, or optionally elsewhere as described above, as well as overlapping information related to the Query Feedback information obtained from the Feedback Warehouse 105, or optionally elsewhere as described above. As can be appreciated by one skilled in the art, the interval set 140 can thus provide more information to a Database Administrator than can the single-column data alone.

A first interval 143, having a relative frequency f₀, is defined to include data values ‘d’ lying in the range (l₀≦d≦u₀), that is, corresponding to the range of the histogram. Note that f₀=1 because the sum of all relative frequencies is equal to 1 in a relative frequency distribution. This is a constraint that can be invoked when applying the principle of maximum entropy to relative frequencies, as shown below.

A second interval 145, having a relative frequency f₁, corresponds to a first Query Feedback Record and includes data values lying in the range (l₁≦d≦u₁), where l₁>l₀ and u₁<u₀. Similarly, a third interval 147, having a relative frequency f₂ and corresponding to a second Query Feedback Record, covers the range (l₂≦d≦u₂), and a fourth interval 149, having a relative frequency f₃ and corresponding to a third Query Feedback Record, covers the range (l₃≦d≦U₃). It should be understood that, for clarity of illustration, only four intervals with corresponding relative frequencies f₀, f₁, f₂, and f₃, are shown in the interval set 140 and projected onto the horizontal coordinate axis 141. However, an interval set derived in accordance with the present inventive method can typically include more than the four intervals shown, as the number of intervals is directly related to the quantity of data obtained from the Query Feedback information and single-column data at steps 121 and 123 above.

For an interval set having more than one triple for the same range of values, for example (l₁, u₁, f₁) and (l₁, u₁, f₂), one of the triples can be eliminated by applying a criterion such as any of the following: (i) a triplet is selected “randomly” for elimination, (ii) a triplet is eliminated in accordance with the order in which the triplets have been stored internally, or (iii) the triplet with the newer timestamp is retained. The information from System Catalog 103 and Feedback Warehouse 105 are then consolidated. The consolidated information may subsequently be sorted by lower boundaries (i.e., lᵢ), and duplicates may be removed from the sorted information.

As can be seen in FIG. 4, the intervals having relative frequencies f₁, f₂, and f₃, that correspond to Query Feedback Records, overlap and extend across only a portion of the horizontal coordinate axis 141. Accordingly, one or more segments of the horizontal coordinate axis 141 may not correspond to any Query Feedback Record and there may be no intervals covering one or more regions of the single-column data domain. A suitable representation for the available information may be found by segmenting the intervals having relative frequencies f₀, f₁, f₂, and f₃, into non-overlapping buckets (herein denoted by ‘r’) from which a system of linear equations can be derived. These equations can also be used as constraints when computing the maximum-entropy frequency distribution.

At step 127 in FIG. 3, the values on the horizontal coordinate axis 141 can be segmented into a set of non-overlapping disjoint buckets {r₁, r₂, . . . , r₇}, where the set {r₁, r₂, . . . , r₇} may be considered a refinement of the set of intervals {I}. A bucket {rₖ} can be specified by a lower boundary lₖ* and an upper boundary uₖ*, where the value lₖ* is a member of either {rₖ₋₁} or {rₖ}, but not both. As is known in the art, a bucket is a region in which the data distribution function is treated as uniform. The proxy data distribution function may be represented as a histogram, the histogram consisting of the set of non-overlapping disjoint buckets {r₁, r₂, . . . , r₇}. The boundaries for the histogram are preferably computed by consolidating all the feedback obtained from the database and creating triples from this feedback. The objectives are to find a distribution that is consistent with the constraints that are defined by the triples obtained in the consolidation step, and to find the distribution that maximizes an entropy function.

The segmentation of the horizontal coordinate axis 141 into the set of non-overlapping buckets {r₁, r₂, . . . , r₇}, in FIG. 4, can be accomplished by any appropriate method including, for example, using a sweep-line algorithm (described in greater detail below), conducting an “Exhaustive Search” to evaluate all possible combinations, conducting a search through sorted lists, or using an algorithm for intersecting geometric figures.

Next, at step 129, the relative frequencies {p₁, p₂, . . . , p₇} of the number of values in each of the plurality of buckets {r₁, r₂, . . . , r₇} needs to be determined in order to specify the data distribution function that will be used to configure the database statistics i.e., to determine the optimal set of statistics to maintain. It is desirable for the relative frequencies to be consistent with the relative frequencies in the fᵢ intervals. By inspection of the interval set 140, a related system of linear equations, representing the consistency constraints on the proxy data distribution function, can be set up in the form:

f₀=p₁+p₂+p₃+p₄+p₅+p₆+p₇

f₁=p₂+p₃+p₄

f₂=p₃+p₄+p₅

f₃=p₄+p₅+p₆

This system of linear equations can be stored in memory (e.g., a part of main memory or a storage medium) as a matrix having the form:

M_{|R|×|T|}

Where |R| is the total number of buckets and |T| is the total number of intervals. For example the system of linear equations above would yield the following matrix:

| | f₀ | f₁ | f₂ | f₃ |
|---|---|---|---|---|
| p₁ | 1 | 0 | 0 | 0 |
| p₂ | 1 | 1 | 0 | 0 |
| P₃ | 1 | 1 | 1 | 0 |
| p₄ | 1 | 1 | 1 | 1 |
| P₅ | 1 | 0 | 1 | 1 |
| P₆ | 1 | 0 | 0 | 1 |
| p₇ | 1 | 0 | 0 | 0 |

It can be appreciated by one skilled in the relevant art that there may be a plurality of data distributions that satisfy the constraints given above and hence are consistent with the data from the System Catalog 103 and Feedback Warehouse 105. The preferred embodiment of the inventive method uses the data distribution P=(p₁, p₂, . . . , p₇) that satisfies the above constraints and has maximum entropy value, defined as,

$$H ( P ) = - {\sum }_{i = 1}^{7} {p}_{i} ln ( \frac{{p}_{i}}{{n}_{i}} )$$

where nᵢ is the length (i.e., the number of integer points) that comprise bucket rᵢ. The relative frequencies for the buckets {r₁, r₂, . . . , rₖ} may be obtained by solving the constrained maximum entropy problem, at step 129. This constrained optimization problem can be solved by, for example, an iterative scaling algorithm, a Newton-Raphson method, or a Simplex method, all well-known in the relevant art. It may be desirable to adjust the values of f₀, through f₃ in order to ensure that the optimization problem has a solution and that the solution algorithm of choice converges to the solution.

The process of applying the maximum-entropy principle to obtain a cumulative distribution function (i.e., the proxy data distribution function) on the selected column may provide a model that is consistent with information retrieved from the System Catalog 103 and the Feedback Warehouse 105 but may otherwise be uniform. Therefore, the distribution having the maximum entropy may be the most unbiased (i.e., uniform) distribution consistent with given constraints with respect to the retrieved information.

It should be understood that the proxy data distribution function is at least as detailed, and preferably more detailed, than the coarse distribution function used by the query optimizer. Because an exact distribution of the data may not be obtainable, a maximum entropy principle can be applied to obtain the proxy data distribution function to represent the “real” distribution of the data. This can be used to compare the quality of the information that the query optimizer is utilizing with the quality of information the query optimizer could be utilizing with better or additional information.

The proxy data distribution function that is obtained via steps 121 through 129 includes the information obtained from query feedback and, as such, can advantageously be used for configuring the database statistics. In an exemplary embodiment, the proxy data distribution function can be used to determine a set of one or more key statistics-configuration parameters such as, for example, the number n of frequent values and m of quantiles to maintain for a corresponding database column, or the parameters for a regression curve selected to approximate the database statistics.

As explained above, frequent values and quantiles may be used by the query optimizer to coarsely approximate the distribution of data within a given column. Having constructed the maximum entropy distribution, which represents the most refined present knowledge about the true distribution of data within the column, a search algorithm may be used to find a pair (n, m) of n frequent values and m quantiles that leads to the coarsified optimizer distribution that best approximates the maximum entropy distribution, that is, the optimal statistics to maintain, at step 131.

Each candidate frequent value and quantile parameter pair (n, m) may be evaluated in accordance with a predetermined error metric. For example, this metric can be a Kolmogorov-Distance value or an Lₚ distance between the proxy data distribution function and the coarse distribution that would be created by the query optimizer, given the frequent value and quantile pair (n, m). An alternative embodiment may evaluate the pair (n, m) with respect to the relative accuracy of a specified set of predicate selectivities under the coarse and maximum-entropy distributions, respectively, where the predicates may come from a query workload.

This procedure may be used to evaluate each possible candidate for the configuration statistics, such as the quantile parameter pair (n, m). That is, one evaluation methodology is to determine how “close” the query optimizer coarse distribution, with the n and m, is to the proxy data distribution function. Another measure of “closeness” can be made by obtaining the predicates from the query workload, as described above, deriving an aggregate measure of accuracy under different distributions, and comparing the accuracies of these distributions. The best candidates may then be obtained by searching though the space of all possible candidates (the “search space”), as described below.

When estimating selectivities for range and equality/inequality predicates, the optimizer may use the frequent values and quantiles. In principle, when considering the interaction of frequent values and quantiles, the frequent values can be seen as points in the cumulative distribution function (quantiles are such points). The query optimizer may use linear interpolation to obtain its coarse distribution and thereby estimate the selectivities of values in between two known points in the distribution that may be a frequent value, a quantile, or both.

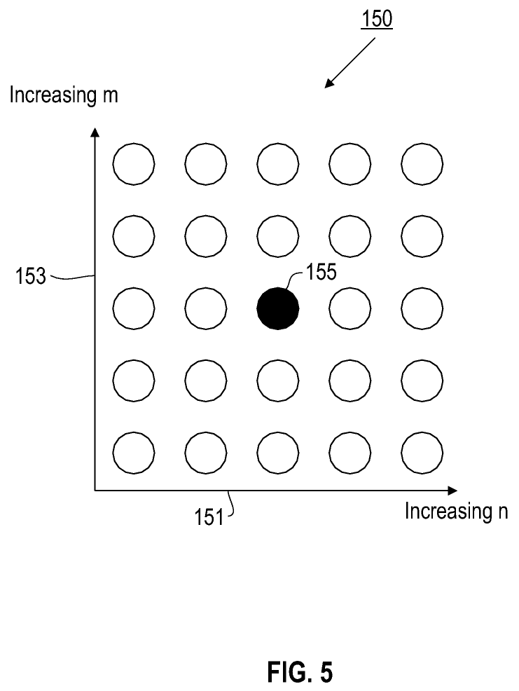

It is known in the art that an ideal number of frequent values and quantiles would include one for each distinct value in the column. But, this may require additional memory resources for the single-column statistics and a corresponding trade-off between accuracy and memory costs. An objective of the search for an optimal frequent value and quantile pair (n, m) is to gather frequent values and quantiles according to a certain error tolerance within a search space having a dimension of one or greater. In the embodiment of FIG. 5, a search space 150 comprises two dimensions.

For purpose of illustration, let ‘o’ denote the current number of frequent values currently specified for the data column, and let ‘q’ denote the current number of quantiles currently specified for the data column. Then, for every pair of values (n, m) such that n≧0 and m≧0, the range of the search space 150 may be defined as:

Q={(o+i,q+j):i={−max_{—}n,−max_{—}n+1, . . . ,−1,0,1, . . . ,max_{—}n−1,max_{—}n} and j={−max_{—}m,−max_{—}m+1, . . . ,−1,0,1, . . . ,max_{—}m−1,max_{—}m}

In the search space 150, the number of frequent values ‘n’ may be plotted across a horizontal axis 151 and the number of quantiles ‘m’ may be plotted across a vertical axis 153. An initial frequent value and quantile pair 155 (i.e., a starting point for the search process) may be denoted by the coordinate values (o, q). The search space may consist of the (m×n) value pairs described above and shown in FIG. 5.

In an exemplary embodiment, an Exhaustive Search is conducted to find the optimal frequent value and quantile pair (nₒₚₜ, mₒₚₜ), not shown. The search space may be limited to a reasonable distance in both the n and m directions to improve performance of the Exhaustive Search. The optimal frequent value and quantile pair (nₒₚₜ, mₒₚₜ) may be stored in a statistics collection in the System Catalog 103 for subsequent use in a statistics collection process of a database system. The optimal frequent values ‘nₒₚₜ’ and the optimal quantiles ‘mₒₚₜ’ indicate the preferred number of quantiles and frequent values for use in collecting statistics, such as in a histogram. At some later time, such as determined by the Database Administrator, the optimal frequent value and quantile pair (nₒₚₜ, mₒₚₜ) can become out-of-date and a new set may be derived in accordance with the process described above.

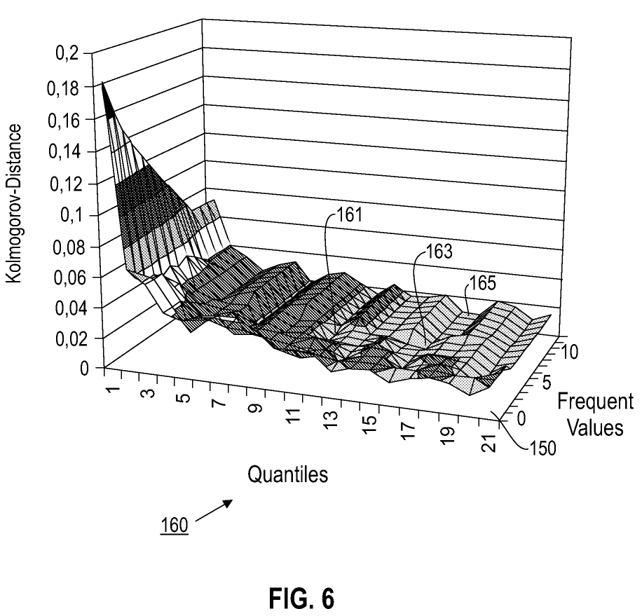

In alternative embodiments, other search techniques such as a Greedy Search with randomized restart or a Tabu Search, may be used. However, it can be appreciated that there may be a plurality of local minima 161, 163, and 163, in the search space 150, as represented in the three-dimensional graph 160 shown in FIG. 6. Such local minima affect the accuracy of a Greedy Search method. The presence of the local minima may not serve to improve the Kolmogorov-Distance, whereby the Kolmogorov-Distance may stay the same, or even degrade, because of the interaction of frequent values with quantiles, and because of the method with which quantiles are gathered. In general, increasing the number of frequent values and quantiles can eventually improve the Kolmogorov-Distance but the improvement is not always assured. It can be appreciated that if a non-Exhaustive Search method is used, the method may reduce the probability that the search “settles” about a local minimum.

### Sweep Line Algorithm

In general, a sweep-line algorithm is a type of algorithm used for intersecting geometric figures, but may be adapted for use in determining the intersection of intervals in a one-dimensional histogram. The objective of using a sweep line algorithm is to determine the boundaries and lengths of buckets {r₁, r₂, . . . , r₇}, as in FIG. 4.

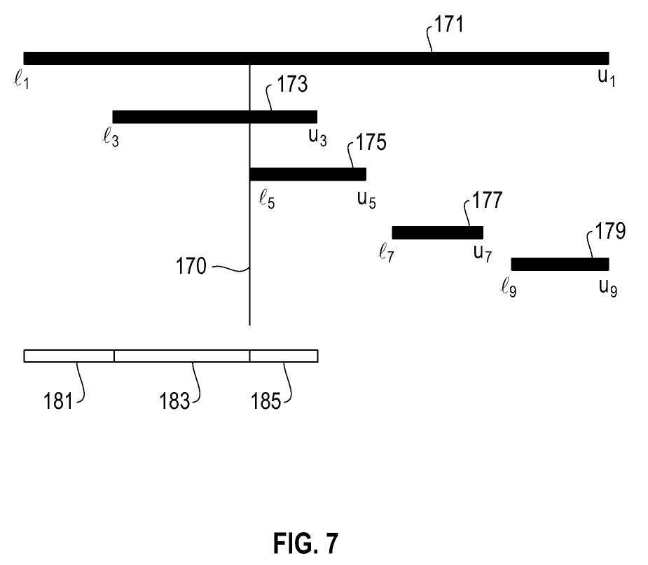

As best seen in FIG. 7, a sweep-line 170 may traverse through a set of sorted intervals 171, 173, 175, 177, and 179. Each time the sweep line 170 reaches a respective lower boundary (l₁, l₃, l₅, l₇, and l₉) a sweep event may occur. When a sweep event occurs, the current interval can be added to a sweep event structure (not shown). The sweep event structure is a heap that holds intervals. The top element in the heap is the interval with the lowest upper boundary.

At the end of each sweep event all found buckets may be added to the matrix. Each time a bucket is added, the contents of the matrix may be updated accordingly. An interval can be deleted from the sweep event structure when the upper boundary has been used to add a bucket.

When trying to find a bucket r there are two main cases that can be differentiated:

I. lower(r) is a lower boundary of an interval

II. lower(r) is an upper boundary of an interval

### A main sweepLine( ) function may handle case I. A cleanHeap( ) function may handle case II. CleanHeap( ) can find all partitions having a lower(r) that is equal to an upper boundary of an interval on the heap as long as upper(head(h))≦lower(c).

The cleanHeap( ) function can be called during a sweep event in which the following state is present: the upper boundary of the head of the heap is smaller than the lower boundary of the current element. Additionally, cleanHeap( ) can be called after the very last sweep event. Finally, the last interval on the heap having an upper boundary that is smaller than the lower boundary of the current interval can be “connected” to the lower boundary of the current element. At this stage in the sweep event, a first bucket 181 and a second bucket 183 have been found, with a third bucket 185 yet to be found.

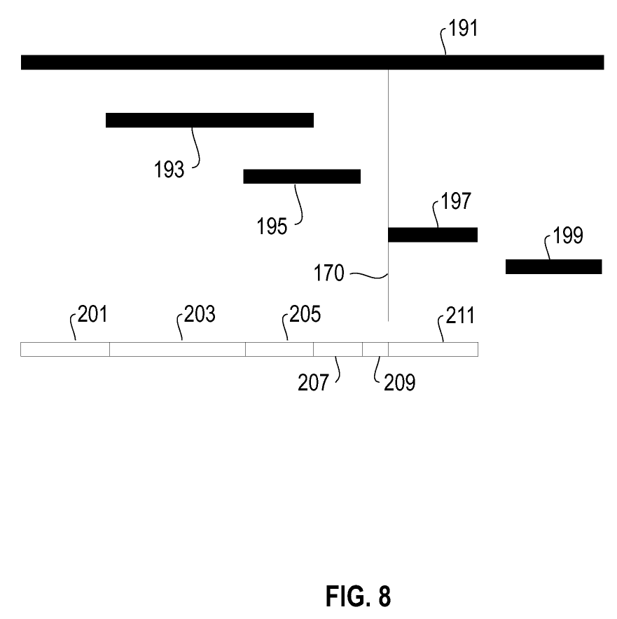

As another example, shown in FIG. 8, the sweep-line 170 may traverse through a second set of sorted intervals 191, 193, 195, 197, and 199. At this stage in the sweep event, a first bucket 201, a second bucket 203, and a third bucket 205 may have been found. A fourth bucket 207 and a fifth bucket 209 can be found by cleanHeap( ). A sixth bucket 211 can be found in the current sweep event.

A general purpose computer may be programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the particular apparatus and method for query feedback-based configuration of database statistics, as herein shown and described in detail, is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”.

All structural and functional equivalents to the elements of the above-described preferred embodiment that are known, or later come to be known to those of ordinary skill in the art, are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

It should further be understood, of course, that the foregoing relates to exemplary embodiments of the invention and that modifications may be made without departing from the spirit and scope of the invention as set forth in the following claims.

We claim:

1. A method for configuring database statistics, said method comprising the steps of:
collecting database information from a database system, said database information including data query feedback;
creating a proxy data distribution function; and
using said proxy data distribution function to configure the database statistics.

2. The method of claim 1 wherein said step of collecting database information comprises at least one of the following steps:
collecting feedback from said database system;
issuing a query to said database system on the fly;
obtaining statistics stored in said database system;
collecting information from said database system by scanning at least a portion of said database information; and
collecting information from said database system by sampling at least a portion of said database information.

3. The method of claim 1 wherein said database information further comprises a data histogram.

4. The method of claim 1 wherein said step of creating a proxy data distribution function comprises the steps of:
consolidating and formatting said database information into a plurality of intervals; and,
converting said plurality of intervals into a plurality of non-overlapping buckets to create said proxy data distribution function.

5. The method of claim 4 wherein said step of consolidating and formatting comprises the step of generating a sequence of triples, each said triple having a minimum value, a maximum value, and a relative frequency of occurrence value.

6. The method of claim 4 wherein said step of converting said plurality of intervals comprises the step of executing an algorithm to determine a boundary and a length for each said bucket, said algorithm being a member of the group consisting of a sweep-line algorithm, an exhaustive search, a search through sorted lists, and an algorithm for intersecting geometric figures.

7. The method of claim 4 wherein said step of converting said plurality of intervals comprises the step of projecting each said interval onto a coordinate axis.

8. The method of claim 1 wherein said step of creating said proxy data distribution function comprises the step of solving a constrained maximum entropy problem.

9. The method of claim 8 wherein said step of solving a constrained maximum entropy problem is executed using any of: an iterative scaling algorithm method, a Newton Raphson method, and a Simplex method.

10. The method of claim 1 wherein the step of using said proxy data distribution function to configure the database statistics comprises the step of determining a set of at least one key statistics-configuration parameter to maintain, said key statistics-configuration parameter selected from a group consisting of: the number of frequent values, the number of quantiles, and the number of regression parameters.

11. The method of claim 10 wherein said step of determining a set of at least one key statistics-configuration parameter comprises the step of performing a search in a search space having a dimension of at least one.

12. The method of claim 11 wherein said step of performing a search comprises the step of conducting at least one of: an exhaustive search, a greedy search with randomized restart, and a Tabu search.

13. The method of claim 1 wherein said step of using said proxy data distribution function to configure the database statistics comprises the step of selecting a statistics-configuration parameter so as to minimize an estimation error between a data optimizer's coarse distribution and said proxy data distribution function.

14. The method of claim 13 wherein said step of minimizing said estimation error comprises the step of determining a distance between said proxy data distribution function and said coarse distribution, said distance being specified as one of a Kolmogorov-Distance and an Lₚ distance.

15. The method of claim 13 further comprising the step of determining the relative accuracy of selectivity estimates for a specified set of predicates based on said data optimizer's coarse distribution with respect to selectivities based on said proxy data distribution function.

16. A method for configuring database statistics obtained from a database system, said method comprising the steps of:
consolidating and formatting data query feedback with an optional histogram computed from single-column data into a set of interval values;
deriving a set of non-overlapping bucket values from said set of interval values;
executing an iterative scaling algorithm method to derive a maximum-entropy frequency value for each said bucket;
converting said bucket frequency values into a proxy data distribution function; and
using said proxy data distribution function to determine key statistics-configuration parameters.

17. The method of claim 16 wherein said step of deriving a set of non-overlapping bucket values comprises the step of executing a sweep line algorithm.

18. The method of claim 17 further comprising the steps of:
obtaining said data distribution function by solving a constrained maximum-entropy problem; and
performing a two-dimensional search to derive an optimal number of quantiles and frequent values.

19. A system for configuring database statistics, said system comprising:
a database for storing data tables;
a system catalog in communication with said database, said system catalog for storing statistical information derived from said data tables; and
a feedback warehouse in communication with said database, said feedback warehouse for storing query results and estimated cardinalities of intermediate steps of previously-executed database queries.

20. The system of claim 19 wherein said statistical information further comprises an optimal number of frequent values and an optimal number of quantiles for at least one column in one of said data tables.

21. A computer program produce comprising a machine readable medium tangibly embodying program instructions thereon, said instructions comprising:
code means for collecting database information from a database system, said database information including data query feedback;
code means for creating a proxy data distribution function; and
code means for using said proxy data distribution function to configure the database statistics.
